(19) United States
(12) Patent Application Publication
(10) Pub. No.: US 2023/0368754 A1
(43) Pub. Date: Nov. 16, 2023

(54) PRINTED MOUTHPIECE LIGATURES

(71) Applicant: ROVNER PRODUCTS INCORPORATED, Timonium, MD (US)

(72) Inventor: George REEDER, Reisterstown, MD (US)

(21) Appl. No.: 18/313,770

(22) Filed: May 8, 2023

Related U.S. Application Data
(60) Provisional application No. 63/339,088, filed on May 6, 2022.

(51) Int. Cl. G10D 9/02; B33Y 10/00; B33Y 80/00

(52) U.S. Cl. CPC G10D 9/02; B33Y 10/00; B33Y 80/00

(57) ABSTRACT

A woodwind mouthpiece ligature includes a plurality of components to secure a reed to a mouthpiece of a wood wind instrument. At least one component from the plurality of components is a printed component that is at least partially created by printing using a three-dimensional printer.

### CROSS-REFERENCE TO RELATED APPLICATIONS

This application claims the benefit of Provisional Patent Application Number 63/339,088 filed May 6, 2022 and titled “Printed Mouthpiece Ligature”. The disclosure of which is incorporated by reference herein in its entirety.

### TECHNICAL FIELD

Embodiments of the subject matter disclosed herein relate to ligatures for single reed woodwind instruments and three-dimensional printing.

### BACKGROUND

Ligatures for woodwind instruments and in particular single reed woodwind instruments, e.g., clarinets and saxophones, surround a mouthpiece and a reed placed over the opening to the tone chamber of the mouthpiece. By surrounding the reed and the mouthpiece, the reed is secured to the mouthpiece using a constrictive force. Conventional ligatures were formed from flexible metal bands that used threaded screws to tighten the ligatures around the mouthpiece and reed. Improved ligatures used a piece of flexible material wrapped around the mouthpiece and reed. The flexible material was tightened around the mouthpiece and reed using fasteners passing through the flexible material or through pins or metal posts that are secured to or otherwise attached to the flexible material.

While ligatures containing the flexible material provide improvements in the use of ligatures and the tonality achieved in the associated instruments, construction of these ligatures includes creating or cutting the desired pieces of flexible material, creating the fasteners and rods from other materials such as metals, and assembling the ligature components together. Adding additional features to the ligature involves additional materials and additional manufacturing steps. Therefore, a ligature and a method for manufacturing that ligature are desired that provide for the appearance and functionality of improved ligatures and that minimize the materials and steps involved in manufacturing that ligature.

### SUMMARY

In one aspect, printed ligatures for woodwind instruments and in particular to printed ligatures for single reed woodwind instruments, e.g., clarinets and saxophones and to methods for making these printed ligatures using a three-dimensional (3D) printer are provided. These printed ligatures include one or more components, and each component can be printed using the 3D printer. Exemplary aspects are also directed to methods for making these ligatures by printing using a 3D printer.

In another aspect, a woodwind mouthpiece ligature is provided having a plurality of components to secure a reed to a mouthpiece of a wood wind instrument. At least one component from the plurality of components is a printed component that is at least partially created by printing using a three-dimensional printer. In one embodiment, the printed component is completely created by printing using a three-dimensional printer. In one embodiment, each component in the plurality of components is at least partially created by printing using a three-dimensional printer. In one embodiment, the plurality of components further includes at least one non-printed component.

In one embodiment, the at least one component is a printed ligature strap. In one embodiment, the plurality of components further includes one or more engagement structures for releasable attachment to the printed ligature strap. In one embodiment, the one or more engagement structures are printed engagement structures that are at least partially created by printing using a three-dimensional printer. In one embodiment, the one or more engagement structures are wire, rope, cord, including elastic cord, and combinations thereof. In one embodiment, the printed ligature strap has a thickness and one or more apertures passing completely through the thickness of the printed ligature strap. The one or more attachment pieces are attached to the apertures.

In one embodiment, the printed ligature strap includes two opposing ends and a length extending along a rectilinear line between the two opposing ends. The printed ligature strap is shaped to eliminate any continuous line of ligature strap material extending between the two opposing lines parallel to the rectilinear line. In one embodiment, the printed ligature strap includes two opposing ends, two sides extending between the opposing ends and spaced from each other, a length extending between the opposing ends, a width extending between the two sides, two opposing surfaces spaced from each other by a thickness perpendicular to the length and the width, and at least one engagement structure printed integrally with the printed ligature strap, running along at least one of the length and the width and representing a modification in the thickness.

In one embodiment, the engagement structure is a channel extending into the thickness from one surface. In one embodiment, the engagement structure is a ridge extending up from one surface. In one embodiment, the engagement structure is a cradle containing two peaks extending up from one surface to a peak height and spaced from each other along the length and a cradle thickness that varies along the length between the two peaks, the cradle thickness less than the ridge peak.

In another aspect, a woodwind mouthpiece is provided having a mouthpiece of a woodwind instrument, a reed in contact with the mouthpiece, and a woodwind mouthpiece ligature containing a plurality of components to secure the reed to the mouthpiece. At least one component from the plurality of components is a printed component that is at least partially created by printing using a three-dimensional printer. In one embodiment, the printed component is completely created by printing using a three-dimensional printer. In one embodiment, the at least one component is a printed ligature strap.

In another aspect, a method for printing a woodwind mouthpiece ligature is provided. This method includes creating a machine-readable file comprising a pre-defined configuration for a given component in a plurality of components in the woodwind mouthpiece ligature, and using the machine-readable file in a three-dimensional printer to print the given component. In one embodiment, the pre-defined configuration defines the entire given component, and the machine-readable file is used in the three-dimensional printer to print the given component completely. In one embodiment, the given component is a printed ligature strap.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a side view of an embodiment of a woodwind mouthpiece ligature containing at least one printed component;

FIG. 2 is another side view of the embodiment of a woodwind mouthpiece ligature containing at least one printed component;

FIG. 3 is an end view of the embodiment of a woodwind mouthpiece ligature containing at least one printed component;

FIG. 4 is a perspective view of the embodiment of a woodwind mouthpiece ligature containing at least one printed component;

FIG. 5 is an exploded view of an embodiment of the knurled knob and threaded rod of the closing mechanism component of the woodwind mouthpiece ligature;

FIG. 6 is a plan view of an exterior surface of an embodiment of a printed ligature strap;

FIG. 7 is a perspective view of the embodiment of a printed ligature strap;

FIG. 8 is a side view of the embodiment of a printed ligature strap;

FIG. 9 is a perspective view of another embodiment of a printed ligature strap showing the exterior surface;

FIG. 10 is a view of the another embodiment of a printed ligature strap showing the interior surface;

FIG. 11 is a plan view of the another embodiment of a printed ligature strap showing the exterior surface;

FIG. 12 is a plan view of an embodiment of an engagement structure;

FIG. 13 is an elevation view of the embodiment of the engagement structure;

FIG. 14 is a plan view of an interior surface of an embodiment a printed ligature strap with an attached engagement structure;

FIG. 15 is a perspective interior view of an interior surface of another embodiment of a printed ligature strap with an attached engagement structure;

FIG. 16 is an elevation view of another embodiment of a printed ligature strap;

FIG. 17 is an end view of an embodiment of a woodwind mouthpiece;

FIG. 18 is a schematic representation of an embodiment of a cradle in a printed mouthpiece ligature;

FIG. 19 is an end view of an embodiment of a woodwind mouthpiece ligature in a first configuration;

FIG. 20 is an end view of the embodiment of a woodwind mouthpiece ligature in a second configuration;

FIG. 21 is a flow chart illustrating an embodiment of a method for printing a woodwind mouthpiece ligature with a three-dimensional printer;

FIG. 22 is a plane view of another embodiment of a printed ligature strap; and

FIG. 23 is a perspective view of another embodiment of a woodwind mouthpiece ligature.

### DESCRIPTION OF THE EMBODIMENTS

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Exemplary embodiments are directed to methods for manufacturing, creating, or forming woodwind mouthpiece ligatures for single reed woodwind instruments. The woodwind mouthpiece ligatures include a plurality of components, and at least a portion or one component of the woodwind mouthpiece ligature is at least partially printed using a three-dimensional (3D) printer. In one embodiment, one of the plurality of components is completely printed using the 3D printer. In one embodiment, the strap portion of the ligature is printed using a (3D) printer, forming a printed ligature strap. Alternatively, all components of the woodwind mouthpiece ligature are printed using a 3D printer. In one embodiment, the plurality of components in the woodwind mouthpiece ligature include non-printed components.

In one embodiment, the 3D printer is controlled by a computer or other suitable controller. Exemplary embodiments are also directed to the woodwind mouthpiece ligatures having a plurality of components wherein at least one component in the plurality of components is a printed component produced by 3D printing and to the woodwind mouthpieces that include these woodwind mouthpiece ligatures.

Suitable 3D printers, controllers, computers, and methods for using the 3D printers are known and available in the art. These 3D printers include, for example, fused deposition modeling 3D printers, stereolithography 3D printers, and selective laser sintering 3D printers. Suitable materials for printing in the 3D printers include, but are not limited to plastics, polymers, and elastomers, for example, polylactic acid, polyamide, polyvinyl alcohol plastic, acrylonitrile butadiene styrene, polyether ether ketone, polyetherimide, and polyphenylsulfone, metals, for example, gold, titanium and stainless steel, graphite, graphene, carbon fiber, nitinol, and paper.

The pre-defined configuration for a given component of the woodwind mouthpiece ligature is created as a computer-readable or machine-readable file. Any suitable method for creating machine-readable files can be used, for example created in a drawing or CAD program or directly in an interface provided on the 3D printer. The pre-defined configuration includes both the structural and functional aspects of the component and any decorative elements of the component including logos. In one embodiment, the pre-defined configuration of the woodwind mouthpiece ligature or the component of the woodwind mouthpiece ligature is stored as the machine-readable or computer-readable file. The machine-readable file is communicated to the 3D printed or controller or computer in communication with the 3D printer and is used by the 3D printer or the controller or computer in communication with the 3D printer to generate the woodwind mouthpiece ligature or the desired component of the woodwind mouthpiece ligature. In one embodiment, multiple copies of the desired woodwind mouthpiece ligature are printed either sequentially or simultaneously using the 3D printer.

In one embodiment, the woodwind mouthpiece ligature is printed as a single-piece ligature that includes all the components of the ligature. Alternatively, the ligature is configured with multiple components, and each component is separately printed. In one embodiment, one or more components of the ligature are printed and are combined with additional non-printed components to form the entire woodwind mouthpiece ligature. Suitable non-printed components include, but at not limited to, metal fasteners, rods, flexible strap, metal strap, carbon fiber material, thumb screws, threaded rods, wire, rope, elastic cord, and twine.

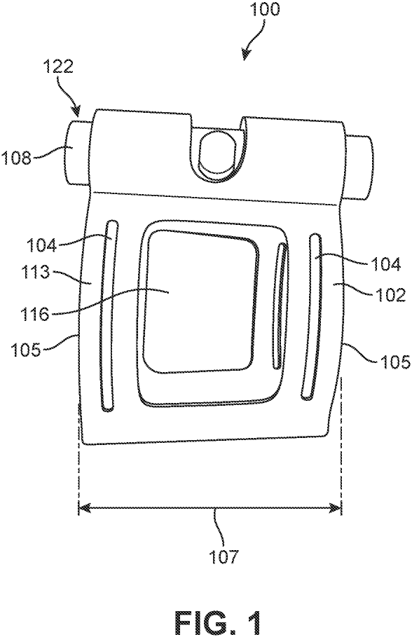

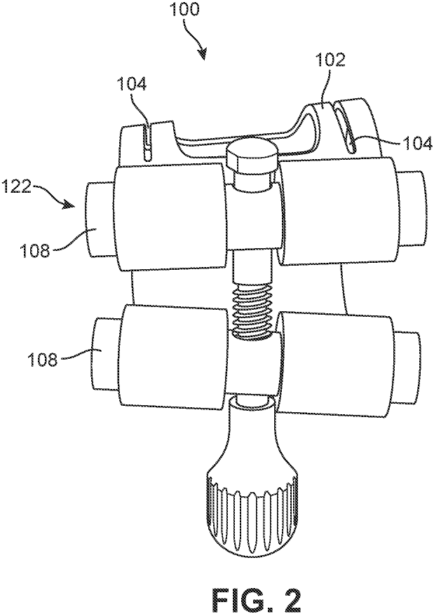

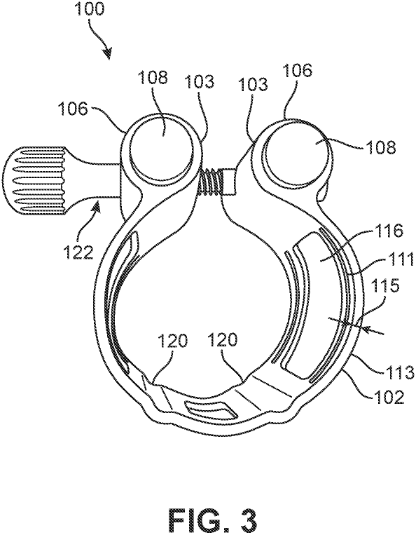

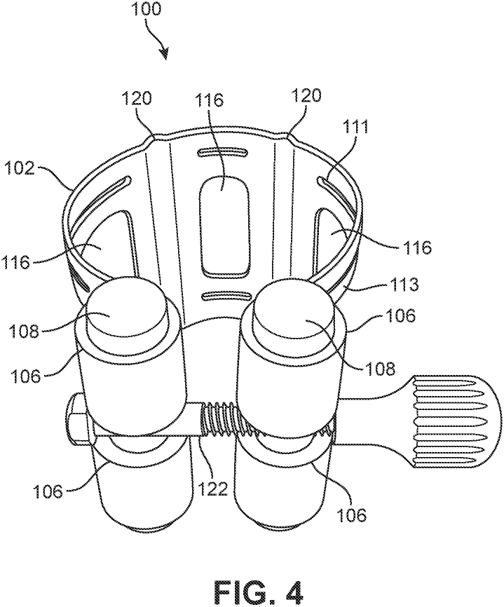

Referring initially to FIGS. 1-4, an embodiment of the woodwind mouthpiece ligature 100 containing a plurality of components including at least one that is a printed portion or component that is at least partially created by printing using the 3D printer is illustrated. As illustrated, the printed component is the ligature strap 102. The ligature strap is configured to surround the mouthpiece and reed. The printed ligature strap includes two opposing ends 103 that are drawn together to secure the reed to the woodwind mouthpiece. The length of the printed ligature strap extends between the two opposing ends. Also extending between the opposing ends are two sides 105 that are spaced from each other to define the width 107 of the printed ligature. The width is perpendicular to the length. The printed ligature strap includes two opposing faces, an interior face 111 and an exterior face 113. The interior face is located adjacent the reed and mouthpiece when the printed ligature strap is attached to a woodwind mouthpiece and reed. The interior face and exterior face are spaced from each other by a thickness 115 of the printed ligature strap. The thickness is perpendicular to both the length and the width.

In one embodiment, the printed ligature strap includes one or more apertures that pass completely through the thickness of the printed ligature strap from the interior face to the exterior face. These apertures are sized and arranged to achieve a desired tonality in the woodwind mouthpiece using the woodwind mouthpiece ligature. In one embodiment, the apertures are used to attach additional structures or components to the ligature strap. These additional components include additional printed components and additional non-printed components. The additional components can be permanently attached to the ligature strap or can be removably attached to the ligature strap. In one embodiment, the additional components include attachment pieces or engagement structures attached to one or more of the apertures.

The apertures include larger gaps or passages 116 along the length of the strap and elongated apertures 104. In one embodiment, the printed ligature strap includes a pair of elongated apertures 104 running along the length of the printed ligature strap and spaced from each other along the width of the printed ligature strap.

In one embodiment, the printed ligature strap includes one or more engagement structures running along at least one of the length and the width of the printed ligature strap. These engagement structures are shaped and positioned to modify or control the engagement between the printed ligature strap and at least one of the reed and the woodwind mouthpiece. In one embodiment, the engagement structures are the additional structures or components that are attached to the printed ligature strap. In one embodiment, the engagement structures are formed into the printed ligature strap and are printed with the printed ligature strap. In one embodiment, the engagement structures represent a modification in the thickness of the printed ligature strap.

As illustrated, the engagement structures are a pair of channels 120 spaced from each other along the length of the printed ligature strap and spanning the width of the printed ligature strap. While illustrated as two channels, the printed ligature strap can include a single channel or three or more channels. Each channel extends into the thickness of the printed ligature strap from the interior face. In one embodiment, each channel represents a decrease in the thickness of the printed ligature strap. Alternatively, each channel represents a bowing or bending of the printed ligature strap outward from the exterior face. These channels are sized, shaped, and arranged to provide for engagement with the edges of the reed when the ligature is used to attach the reed to a mouthpiece.

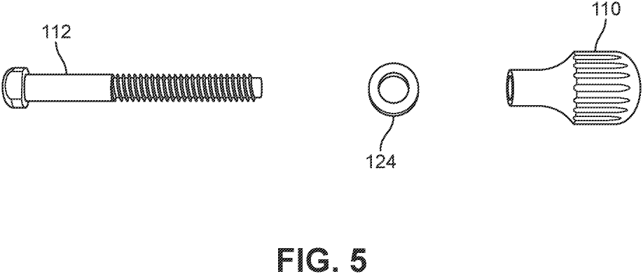

At either end of the strap are a plurality of loops 106 configured to secure the components of a closing mechanism 122 to the printed ligature strap. In one embodiment, the components of the closing mechanism are included in the plurality of components of the woodwind mouthpiece ligature. As illustrated, each end of the printed ligature strap includes two loops. However, each end of the printed ligature strap can include less than or more than two loops. Each pair of loops 106 at each end of the printed ligature strap holds one of a pair of metal bars 108 inserted through the loops. The rods and loops form part of the closing mechanism of the printed ligature strap. Referring to FIG. 5, the closing mechanism also includes a threaded rod 112 for insertion through both metal bars, a knurled knob 110, and one or more washers 124. One or more of these components of the closing mechanism can be printed components that are printed using a 3D printer or non-printed components formed using other methods.

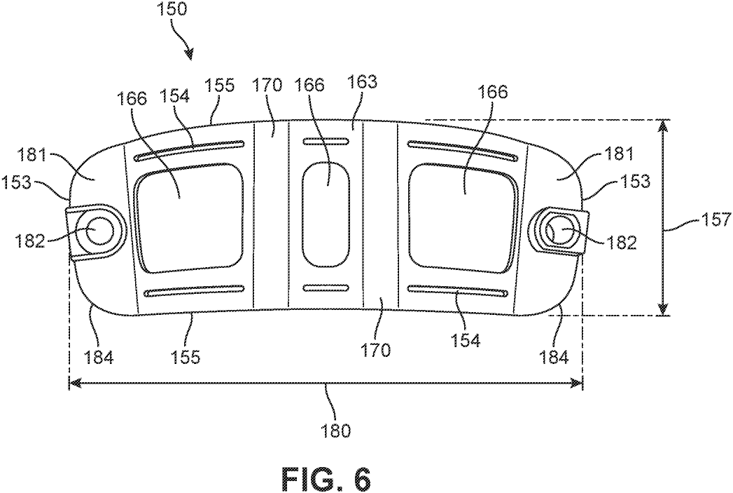

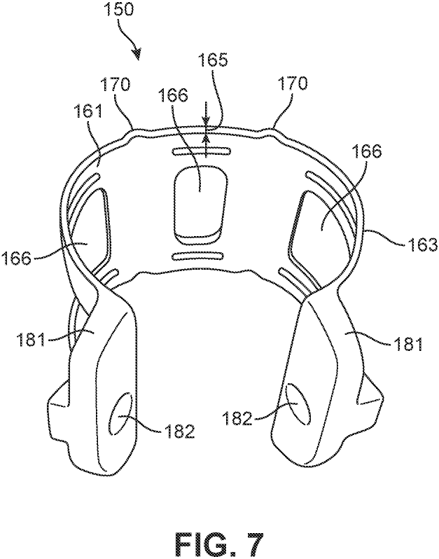

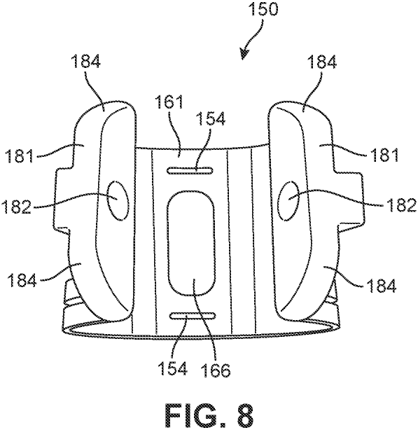

Referring now to FIGS. 6-8, another embodiment of the printed ligature strap 150 is illustrated. In this embodiment, the ligature strap is arranged to eliminate the need for the metal bars in the closing mechanism. The printed ligature strap includes the two opposing ends 153 that are drawn together to secure the reed to the woodwind mouthpiece. The length 180 of the printed ligature strap extends between the two opposing ends. Also extending between the opposing ends are two sides 155 that are spaced from each other to define the width 157 of the printed ligature strap. The width is perpendicular to the length. The printed ligature strap includes two opposing faces, an interior face 161 and an exterior face 163. The interior face is located adjacent the reed and mouthpiece when the printed ligature strap is attached to a woodwind mouthpiece and reed. The interior face and exterior face are spaced from each other by a thickness 165 of the printed ligature strap. The thickness is perpendicular to both the length and the width.

In one embodiment, the printed ligature strap includes one or more apertures that pass completely through the thickness of the printed ligature strap from the interior face to the exterior face. These apertures are sized and arranged to achieve a desired tonality in the woodwind mouthpiece using the woodwind mouthpiece ligature. In one embodiment, the apertures are used to attach additional structures or components to the ligature strap. These additional components include additional printed components and additional non-printed components. The additional components can be permanently attached to the ligature strap or can be removably attached to the ligature strap. In one embodiment, the additional components include attachment pieces and engagement structures attached to one or more of the apertures.

The apertures include larger gaps or passages 166 along the length of the strap and elongated apertures 154. In one embodiment, the printed ligature strap includes a pair of elongated apertures 154 running along the length of the printed ligature strap and spaced from each other along the width of the printed ligature strap.

In one embodiment, the printed ligature strap includes one or more engagement structures running along at least one of the length and the width printed ligature strap. As illustrated, the engagement structures are a pair of channels 170 spaced from each other along the length of the printed ligature strap and spanning the width of the printed ligature strap. While illustrated as two channels, the printed ligature strap can include a single channel or three or more channels. Each channel extends into the thickness of the printed ligature strap from the interior face. In one embodiment, each channel represents a decrease in the thickness of the printed ligature strap. Alternatively, each channel represents a bowing or bending of the printed ligature strap outward from the exterior face. These channels are sized, shaped, and arranged to provide for engagement with the edges of the reed when the ligature is used to attach the reed to a mouthpiece.

Opposing ends 153 of the printed ligature strap are printed as thickened portions 181 that extend in from the opposing ends. These thickened portions provide sufficient structural strength to function as part of the closing mechanism of the woodwind mouthpiece ligature. Therefore, metal bars are not required for the closing mechanism. Each end includes a circular passage 182 for a threaded rod, knurled knob, and washers. In one embodiment, the thickened positions are further reinforced by additional material around each circular passage. When attached to a mouthpiece, the thickened portions extend radially outward from the mouthpiece and reed. The corners 184 of each thickened portion are rounded or otherwise relieved to provide for improved fit and playing comfort.

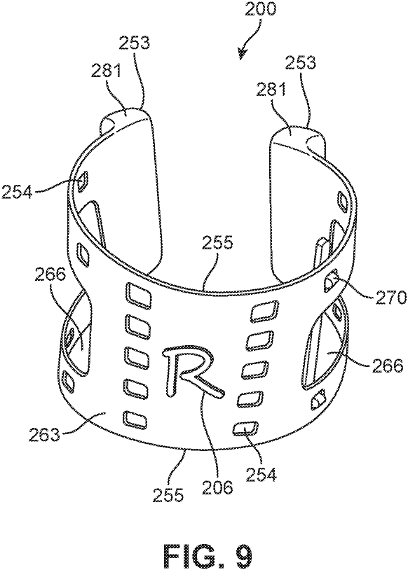

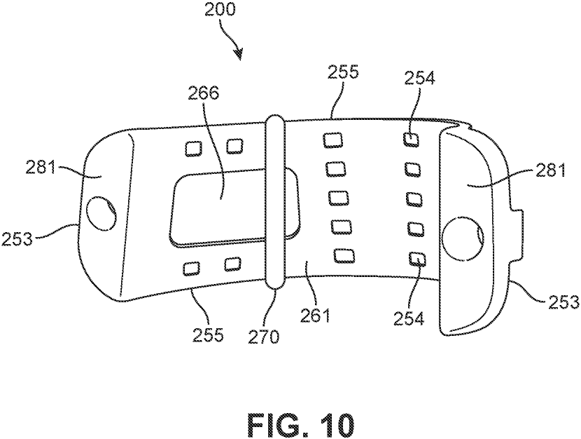

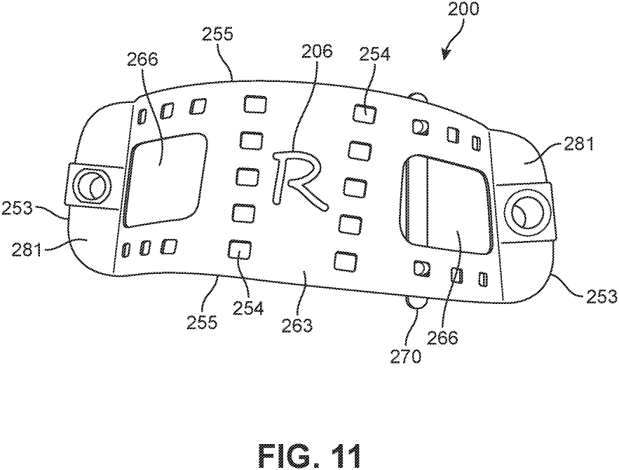

Referring now to FIGS. 9-11, another embodiment of the printed ligature strap 200 is illustrated. The printed ligature strap includes the two opposing ends 253 that are drawn together to secure the reed to the woodwind mouthpiece. The length of the printed ligature strap extends between the two opposing ends. Also extending between the opposing ends are two sides 255 that are spaced from each other to define the width of the printed ligature strap. The width is perpendicular to the length. The printed ligature strap includes two opposing faces, an interior face 261 and an exterior face 263. The interior face is located adjacent the reed and mouthpiece when the printed ligature strap is attached to a woodwind mouthpiece and reed. The interior face and exterior face are spaced from each other by a thickness of the printed ligature strap. The thickness is perpendicular to both the length and the width.

In one embodiment, the printed ligature strap includes one or more apertures that pass completely through the thickness of the printed ligature strap from the interior face to the exterior face. These apertures are sized and arranged to achieve a desired tonality in the woodwind mouthpiece using the woodwind mouthpiece ligature. In one embodiment, the apertures are used to attach additional structures or components to the ligature strap. These additional components include additional printed components and additional non-printed components. The additional components can be permanently attached to the ligature strap or can be removably attached to the ligature strap. In one embodiment, the additional components include attachment pieces attached to one or more of the apertures.

The apertures include larger gaps or passages 266 along the length of the strap and a plurality of discrete holes 254 passing through the ligature strap. In one embodiment, the discrete holes are arranged in lines extending along at least one of the length and width of the printed ligature strap. In one embodiment, the apertures also include one or more elongated apertures running along the length of the printed ligature strap and spaced from each other along the width of the printed ligature strap.

In one embodiment, the printed ligature strap includes one or more attachment pieces or engagement structures 270 extending along at least one of the length and the width printed ligature strap. As illustrated, the engagement structure is a separate structure that is attached to the printed ligature strap using one or more of the discrete holes. While illustrated with a single engagement structure, the woodwind mouthpiece can include two of more engagement structures. These engagement structures are sized, shaped, and arranged to provide for engagement with the edges of the reed when the ligature is used to attach the reed to a mouthpiece. In general, each engagement structure is included in the plurality of components of the woodwind mouthpiece ligature. The engagement structure can be a printed structure or a non-printed structure.

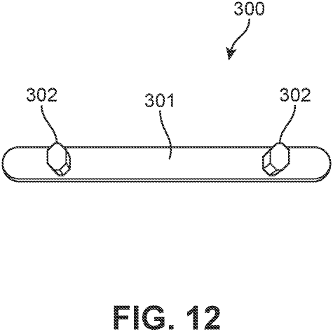

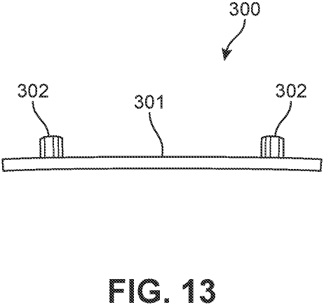

Referring now to FIGS. 12 and 13, an embodiment of a printed engagement structure 300 is illustrated. In one embodiment, the printed attachment piece is printed from the same material as the ligature strap. Alternatively, the printed attachment piece is printed from a separate material. One, two or more of the printed attachment pieces can be attached to any of the ligature straps disclosed herein. In one embodiment, the printed attachment piece includes a main body 301 that extends along the width of the printed ligature strap and one or more posts 302 extending from the main body that engage the holes in the ligature strap. The posts can be used to permanently or releasably attach the printed attachment piece to the ligature strap. The main body engages at least one of the reed and the mouthpiece when the printed ligature strap is attached to a woodwind mouthpiece.

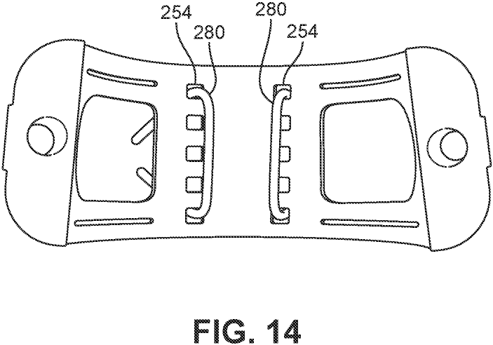

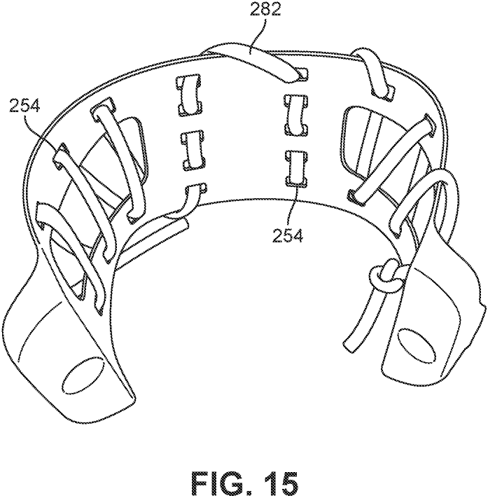

Other engagement structures that can be permanently or releasably attached to the apertures of the printed ligature strap include non-printed engagement structures. Suitable non-printed engagement structures include metal wire, rope, cord, twine, elastic cord, ribbon, or combinations thereof. These engagement structures are arranged to provide the desired engagement between the printed ligature strap and at least one of the reed and woodwind mouthpiece. In addition, these engagement structures are selected based on the material of the engagement structure, e.g., rigid, elastic, soft, and cushioning. Referring to FIG. 14, the engagement structure includes a pair of metals wires 280. Suitable metal wires include copper, steel, aluminum, and brass wires. Each wire passes through two of the holes 254 in the printed ligature strap and extends along the width of printed ligature strap adjacent the interior surface. Referring to FIG. 15, in another embodiment the engagement structure includes a length of elastic cord 282 passing through a plurality of the holes 254 in the printed ligature strap. In one embodiment, the length of elastic cord passes through all the holes in the printed ligature strap. The length of elastic cord is woven through the holes to achieve the desired pattern of engagement between the elastic cord and at least one of the reed and the woodwind mouthpiece.

Returning to FIGS. 9-11, opposing ends 253 of the printed ligature strap are printed as thickened portions 281 that extend in from the opposing ends. These thickened portions provide sufficient structural strength to function as part of the closing mechanism of the woodwind mouthpiece ligature. Therefore, metal bars are not required for the closing mechanism. Each end includes a circular passage for a threaded rod, knurled knob, and washers. In one embodiment, the thickened positions are further reinforced by additional material around each circular passage. When attached to a mouthpiece, the thickened portions extend radially outward from the mouthpiece and reed. The corners of each thickened portion are rounded or otherwise relieved to provide for improved fit and playing comfort. In one embodiment, the printed ligature strap 200 includes logos 206 or other designs or markings on the exterior surface of the ligature strap.

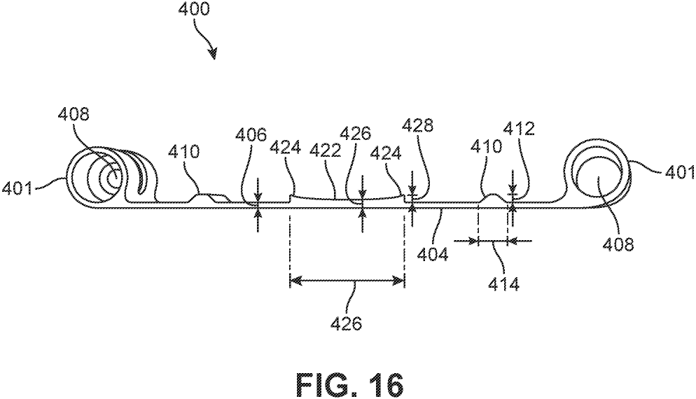

In one embodiment, the printed ligature strap is printed as a flat strap on a support surface of the 3D printer beginning at either the exterior surface or the interior surface. Referring now to FIG. 16, another embodiment of a printed mouthpiece ligature 400 is illustrated. The printed mouthpiece ligature includes two opposing ends 401 and two opposing faces or surfaces, an interior surface 402 and an exterior surface 404 opposite the interior surface. Either the interior surface or the exterior surface has a generally smooth surface; however, the interior surface or the exterior surface can have a texture, for example, a texture resulting from the three-dimensional printing process. In one embodiment, the printed ligature strap has a thickness 406 of about 1 mm or from 1 mm to 2 mm. Each end of the ligature is formed with loops 408 and slots to accommodate the metal bars and closing mechanism used to close and secure the ligature around the mouthpiece and reed. While illustrated with the loops, each end of the printed ligature strap can be configured in accordance with any of the embodiments illustrated herein, including embodiments that utilize a threaded rod and knurled knob without the metal bars.

The interior surface includes at least one engagement structure that is printed integrally with the printed ligature strap. The printed engagement structure extends along at least one of the length and the width of the printed ligature strap. In one embodiment, the printed engagement structure comprises a modification in the thickness 406 of the printed ligature strap. In one embodiment, the engagement structure comprises at least one ridge 410 extending up from the interior surface or the exterior surface to a desired ridge height 412 above the surface. Preferably, the ridge extends from the interior surface. In one embodiment, the printed ligature strap includes two ridges spaced from each other along the length of the printed ligature strap. While illustrated with two ridges, the printed ligature strap can also include three or more ridges. Each ridge extends at least partially, and preferably completely, across the width of the printed ligature strap. The number of ridges, the cross-sectional shape of the ridges, the location of each ridge along the length of the ligature strap, and the angle at which each ridge extends across the width of the mouthpiece can be varied.

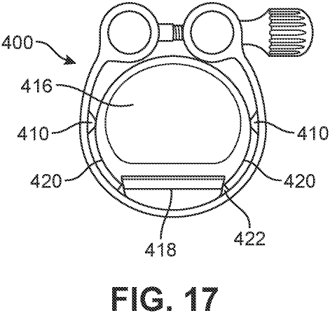

In one embodiment, each ridge extends up from the ligature a distance 412 of up to 2 mm and extends along the length of the ligature strap by a distance 414 of up to about 5 mm. In one embodiment, each ridge has a triangular or conical cross-section, becoming narrower as it extends up from the interior surface of the ligature strap. Each ridge is positioned to engage at least one of the mouthpiece or reed of the woodwind mouthpiece. For example, as illustrated in FIG. 17, when placed around a mouthpiece 416 and a reed 418, each ridge 410 engages the mouthpiece 416 and creates or defines a gap 420 between the mouthpiece and the printed ligature strap 400. In one embodiment, the mouthpiece only engages the ridges of the printed ligature strap. Therefore, each ridge and associated gap function as a printed ligature strap isolation feature that spaces the ligature from the mouthpiece when the ligature is attached to the mouthpiece. This prevents the communication or transmission of undesired vibrations and frequencies.

Returning to FIG. 16, in addition to or as an alternative to the ridges, the printed ligature strap includes a cradle 422 extending up from the interior surface or the exterior surface. Preferably, the cradle extends up from the interior surface. In one embodiment, the cradle is centered along the length of the printed ligature strap and extends at least partially along the width. In one embodiment, the cradle extends along the entire width of the printed ligature strap. Referring to FIG. 17, the cradle 422 is shaped to accommodate and to engage the heel end of the reed 418 when the printed ligature strap is attached to the mouthpiece and reed. Returning to FIG. 16, in one embodiment, the cradle extends a distance 426 of about 20 mm along the length of the ligature and extends up away from the ligature strap on either end of the cradle to opposing peaks. In one embodiment, each peak is located at a distance 428 of about 1 mm or of about 2 mm.

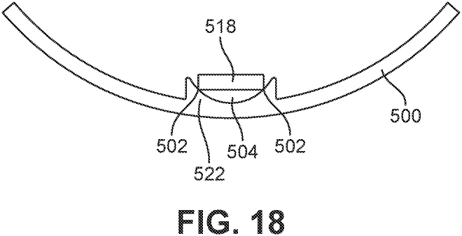

The cradle thickness 426 varies along the length between the two peaks. In one embodiment, this variance is a smooth curve. The shape or curvature of the cradle provides for the desired engagement between the cradle and the reed. In one embodiment, the cradle generally engages the sides of the heel of the reed and holds the reed and ligature in place, preventing movement around the mouthpiece between the reed and the ligature. In one embodiment, the cradle mirrors the curvature of the heel end of the reed. Referring to FIG. 18, in one embodiment, the cradle 522 in the printed ligature strap 500 is shaped and sized to engage only the edges 502 of the heel end of the reed 518. The curvature of the ligature and the cradle in combination with the relative stiffness of the material of the ligature results in a space or air gap 504 between the reed and the cradle area of the ligature. In one embodiment, the material of the printed ligature strap and the cradle and ridges provide the desired rigidity in the ligature that space the ligature from the reed and mouthpiece.

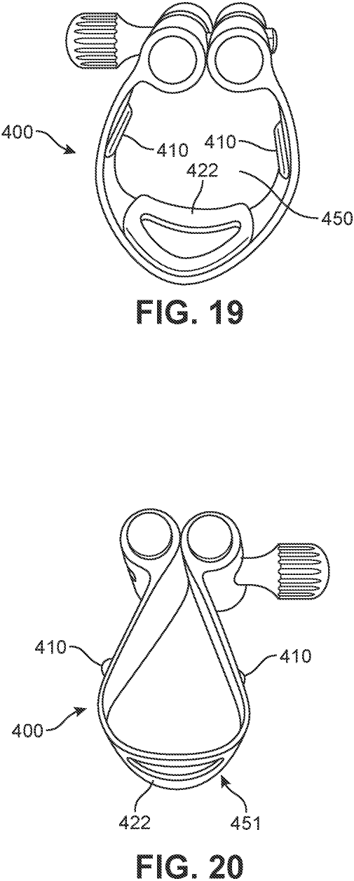

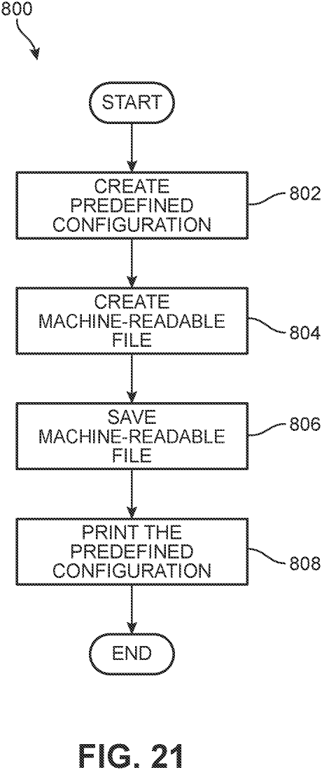

In one embodiment, the material of the printed ligature strap and the arrangement of the cradle and ridges on one surface of the printed ligature strap provide for a two-sided, reversible printed ligature strap. As illustrated in FIG. 19, the printed ligature strap 400 is placed in a first configuration wherein the ridges 410 and cradle 422 are positioned on the interior 450 of the printed ligature strap to engage the mouthpiece and reed. Referring to FIG. 20, the same printed ligature strap 400 is positioned in a second configuration where the ridges 410 and cradle 422 are on the outside 451 of the printed ligature strap and do not engage the mouthpiece and reed. In this embodiment, the smooth or textured surface of the printed ligature strap is arranged to engage the mouthpiece and reed. However, the stiffness of the ligature is still sufficient to create spaces and air gaps between the mouthpiece and ligature as desired.

While illustrated as having a smooth side and a side containing the cradle and ridges, other embodiments are possible in which both surfaces have a different cradle, different arrangements of ridges, or a different cradle and different arrangements of ridges. Alternatively, one surface can have the cradle and be otherwise flat or smooth. In one embodiment, the ligature is configured with different shapes of cradles on either side. In general, any desired arrangement of cradles, ridges or smooth surfaces can be applied to either side of the ligature. Therefore, each printed ligature strap is a reversible ligature strap that functions as two separate ligature straps that each provide a unique functionality and tonality to the ligature, mouthpiece, reed, and musical instrument.

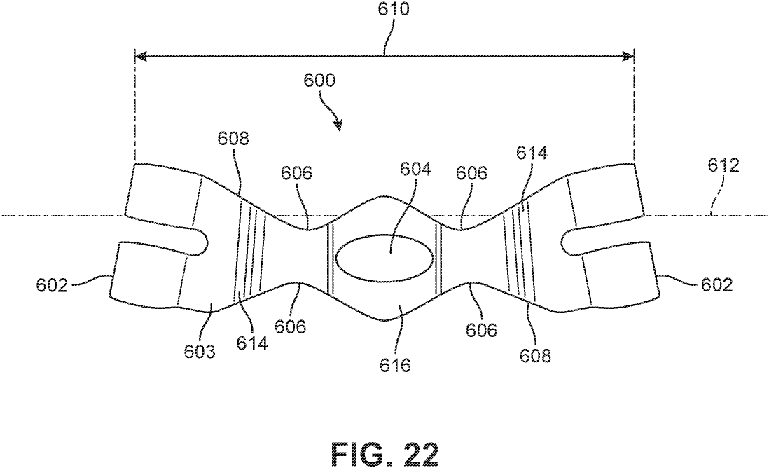

Referring now to FIG. 22, another embodiment of a printed ligature strap 600 for a single-reed woodwind instrument is illustrated. This embodiment of a printed ligature strap is made using any of the materials or methods disclosed herein including using three-dimensional printers and materials that are suitable for printing with a three-dimensional printer. As illustrated, the ligature includes an interior surface 602 and an exterior surface opposite the interior surface. The interior and exterior surfaces can be smooth or can have textures. In one embodiment, each end 602 in the two opposing ends of the printed ligature strap is formed with loops and a slot to accommodate the metal bars, threaded rod and knurled knob used to close and secure the ligature around the mouthpiece and reed. While illustrated with the loops, each end of the ligature can be configured in accordance with any of the embodiments illustrated herein, including embodiments that utilize a threaded rod and knurled knob without the metal bars as disclosed herein.

Along the length of the ligature is at least one opening or hole 604 and a plurality of curves or indentations 606 extending into the printed ligature strap 600 from the sides 608. The central hole 604 passes completely through the printed ligature strap. As illustrated, the hole 604 is centered along the length 610 of the ligature. In one embodiment, the central hole is an oblong or oval hole. This oblong hole can have dimensions of about 9 mm by about 18 mm or from up to about 10 mm to up to about 20 mm. However, the central hole can be a circular hole or can have other shapes such as rectangular, square, and triangular. In one embodiment, the ligature includes a plurality of separate and independent holes. Each curve or indentation 606 represents a decrease in the width of the printed ligature strap.

In general, the arrangement of the holes and curves or indentations is selected to avoid or to eliminate a solid, complete, or uninterrupted piece of ligature along any line 612 extending between the ends of the printed ligature strap. Eliminating continuous bands of ligature material between the ends of the printed ligature strap and along the length of the ligature strap makes it difficult for unwanted vibrational frequencies to propagate through the ligature. Limiting the ability of unwanted vibrational frequencies to propagate through the ligature achieves the same benefit of having multiple slits or kerfs running along the length of the ligature strap. In one embodiment, the hole in the ligature strap also provides a visual aid that is used to position the reed between the ligature and the mouthpiece.

In one embodiment, the printed ligature strap also includes an arraignment of ridges 614 and a cradle 616 as discussed herein. The number of ridges, the cross-sectional shape of the ridges, the location of each ridge along the length of the ligature strap, and the angle at which each ridge extends across the width of the mouthpiece can be varied. In one embodiment, the interior surface of the ligature strap includes the cradle 616 disposed around the hole 604 in the ligature.

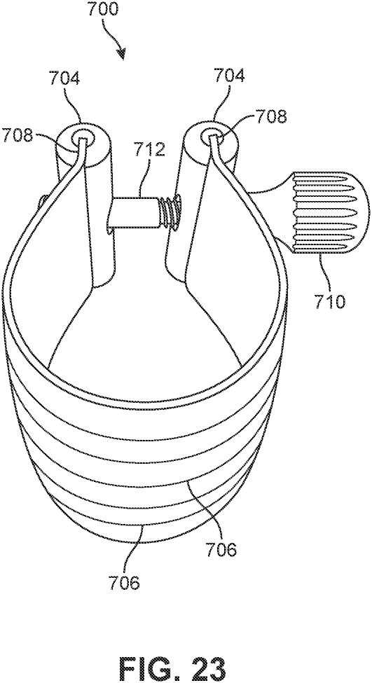

Referring to FIG. 23, another embodiment of a printed ligature strap 700 is illustrated. The printed ligature strap is printed as a single flat piece of strap. In one embodiment, an arrangement of one or more slots, slits, or kerfs 706 are printed into the printed ligature strap. In one embodiment, the slots, slits, or kerfs are cut into the printed ligature strap. The printed ligature includes metal bars 704 attached to either end of the printed ligature strap. In one embodiment, each metal bar includes a passage 708 running along the length of the metal bar. An end of the printed ligature strap is inserted into the metal bar and is used to attach the metal bar to the printed ligature strap. The metal bars function as part of the closing mechanism of the printed ligature and have through holes to accommodate the threaded rod 712 and knurled knob 710 portion of the closing mechanism.

In general, any arrangement of the components including the various embodiments of the printed ligature strap can be combined to create the desired woodwind mouthpiece ligature. This includes combining the features of different embodiments of the printed ligature strap. In addition, exemplary embodiments are also directed to a woodwind mouthpiece that includes any embodiment of the woodwind mouthpiece ligature in combination with a mouthpiece and a reed in contact with the mouthpiece. Any arrangement of a woodwind mouthpiece ligature comprising a plurality of components to secure the reed to the mouthpiece as disclosed herein can be used. At least one component from the plurality of components is a printed component that is at least partially created by printing using a three-dimensional printer. In one embodiment, the printed component is completely created by printing using a three-dimensional printer.

Referring now to FIG. 21, exemplary embodiments are also directed to a method for manufacturing or printing a woodwind mouthpiece ligature that includes one or more components of the woodwind mouthpiece ligature as described herein. For the woodwind mouthpiece ligature, or a given component of the woodwind mouthpiece ligature, a pre-defined configuration is created 802. In one embodiment, the given component is a printed ligature strap. This includes a printed ligature strap according to any of the embodiments described herein. Any suitable method for creating a pre-defined configuration can be used including using a drawing program on a computer, drawing a picture of the pre-defined configuration by hand, and creating a physical model of the pre-defined configuration. The pre-defined configuration defines the entire component or only a portion of the entire component.

A machine-readable file containing the pre-defined configuration for a given component in a plurality of components in the woodwind mouthpiece ligature is created 804. Suitable methods for creating the machine-readable or computer-readable file include, but are not limited to, using the computer based drawing program to create the machine-readable file, scanning a drawing of the pre-defined configuration, or taking of picture of the drawing or physical model. In one embodiment, the machine-readable file is saved 806, for example, to a memory.

The machine-readable file is used in a three-dimensional printer to print the pre-defined configuration 808, e.g., the given component, plurality of components or woodwind mouthpiece ligature. In one embodiment, the machine-readable file is used in a controller of the three-dimensional printer or in a computer in communication with the three-dimensional printed to create the pre-defined configuration of the woodwind mouthpiece ligature or one or more components of the woodwind mouthpiece ligature. The three-dimensional printer is then used to print the pre-defined configuration for the woodwind mouthpiece ligature or component at least partially and preferably completely. In one embodiment, components are printed in a flat orientation and are then bent into a desired shaped. Alternatively, the components are printed in the desired shaped to accommodate, for example, a mouthpiece and reed. This process is completed for each component that is to be 3D printed. Having printed multiple components, either contemporaneously or in series, the printed components, along with any non-printed components are assembled into the woodwind mouthpiece ligature.

The processes and methods for 3D printing of the embodiments described in this detailed description and shown in the figures can be implemented using any kind of computing system having one or more central processing units (CPUs) and/or graphics processing units (GPUs). The processes and methods of the embodiments could also be implemented using special purpose circuitry such as an application specific integrated circuit (ASIC). The processes and methods of the embodiments may also be implemented on computing systems including read only memory (ROM) and/or random access memory (RAM), which may be connected to one or more processing units. Examples of computing systems and devices include, but are not limited to servers, cellular phones, smartphones, tablet computers, notebook computers, e-book readers, laptop or desktop computers, all-in-one computers, as well as various kinds of digital media players.

The processes and methods of the embodiments can be stored as instructions and/or data on non-transitory computer-readable media. The non-transitory computer readable medium may include any suitable computer readable medium, such as a memory, such as RAM, ROM, flash memory, or any other type of memory known in the art. In some embodiments, the non-transitory computer readable medium may include, for example, an electronic storage device, a magnetic storage device, an optical storage device, an electromagnetic storage device, a semiconductor storage device, or any suitable combination of such devices. More specific examples of the non-transitory computer readable medium may include a portable computer diskette, a floppy disk, a hard disk, magnetic disks or tapes, a read-only memory (ROM), a random access memory (RAM), a static random access memory (SRAM), a portable compact disc read-only memory (CD-ROM), an erasable programmable read-only memory (EPROM or Flash memory), electrically erasable programmable read-only memories (EEPROM), a digital versatile disk (DVD and DVD-ROM), a memory stick, other kinds of solid state drives, and any suitable combination of these exemplary media. A non-transitory computer readable medium, as used herein, is not to be construed as being transitory signals, such as radio waves or other freely propagating electromagnetic waves, electromagnetic waves propagating through a waveguide or other transmission media (e.g., light pulses passing through a fiber-optic cable), or electrical signals transmitted through a wire.

Instructions stored on the non-transitory computer readable medium for carrying out operations of the present invention may be instruction-set-architecture (ISA) instructions, assembler instructions, machine instructions, machine dependent instructions, microcode, firmware instructions, configuration data for integrated circuitry, state-setting data, or source code or object code written in any of one or more programming languages, including an object oriented programming language such as Smalltalk, C++, or suitable language, and procedural programming languages, such as the “C” programming language or similar programming languages.

Aspects of the present disclosure are described in association with figures illustrating flowcharts and/or block diagrams of methods, apparatus (systems), and computing products. It will be understood that each block of the flowcharts and/or block diagrams can be implemented by computer readable instructions. The flowcharts and block diagrams in the figures illustrate the architecture, functionality, and operation of possible implementations of various disclosed embodiments. Accordingly, each block in the flowchart or block diagrams may represent a module, segment, or portion of instructions. In some implementations, the functions set forth in the figures and claims may occur in an alternative order than listed and/or illustrated.

The embodiments may utilize any kind of network for communication between separate computing systems. A network can comprise any combination of local area networks (LANs) and/or wide area networks (WANs), using both wired and wireless communication systems. A network may use various known communications technologies and/or protocols. Communication technologies can include, but are not limited to: Ethernet, 802.11, worldwide interoperability for microwave access (WiMAX), mobile broadband (such as CDMA, and LTE), digital subscriber line (DSL), cable internet access, satellite broadband, wireless ISP, fiber optic internet, as well as other wired and wireless technologies. Networking protocols used on a network may include transmission control protocol/Internet protocol (TCP/IP), multiprotocol label switching (MPLS), User Datagram Protocol (UDP), hypertext transport protocol (HTTP), hypertext transport protocol secure (HTTPS) and file transfer protocol (FTP) as well as other protocols.

Data exchanged over a network may be represented using technologies and/or formats including hypertext markup language (HTML), extensible markup language (XML), Atom, JavaScript Object Notation (JSON), YAML, as well as other data exchange formats. In addition, information transferred over a network can be encrypted using conventional encryption technologies such as secure sockets layer (SSL), transport layer security (TLS), and Internet Protocol security (Ipsec).

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A woodwind mouthpiece ligature comprising a plurality of components to secure a reed to a mouthpiece of a wood wind instrument, wherein at least one component from the plurality of components comprises a printed component that is at least partially created by printing using a three-dimensional printer.

2. The woodwind mouthpiece ligature of claim 1, wherein the printed component is completely created by printing using a three-dimensional printer.

3. The woodwind mouthpiece ligature of claim 1, wherein each component in the plurality of components is at least partially created by printing using a three-dimensional printer.

4. The woodwind mouthpiece ligature of claim 1, wherein the plurality of components further comprises at least one non-printed component.

5. The woodwind mouthpiece ligature of claim 1, wherein the at least one component comprises a printed ligature strap.

6. The woodwind mouthpiece ligature of claim 5, wherein the plurality of components further comprises one or more engagement structures for releasable attachment to the printed ligature strap.

7. The woodwind mouthpiece ligature of claim 6, wherein the one or more engagement structures comprise printed engagement structures that are at least partially created by printing using a three-dimensional printer.

8. The woodwind mouthpiece ligature of claim 6, wherein the one or more engagement structures comprise wire, rope, cord, or combinations thereof.

9. The woodwind mouthpiece ligature of claim 6, wherein the printed ligature strap comprises a thickness and one or more apertures passing completely through the thickness of the printed ligature strap, the one or more attachment pieces attached to the apertures.

10. The woodwind mouthpiece ligature of claim 5, wherein the printed ligature strap comprises:
two opposing ends; and
a length extending along a rectilinear line between the two opposing ends;
wherein the printed ligature strap is shaped to eliminate any continuous line of ligature strap material extending between the two opposing lines parallel to the rectilinear line.

11. The woodwind mouthpiece ligature of claim 5, wherein the printed ligature strap comprises:
two opposing ends;
two sides extending between the opposing ends and spaced from each other;
a length extending between the opposing ends;
a width extending between the two sides;
two opposing surfaces spaced from each other by a thickness perpendicular to the length and the width; and
at least one engagement structure printed integrally with the printed ligature strap, running along at least one of the length and the width and comprising a modification in the thickness.

12. The woodwind mouthpiece ligature of claim 11, wherein the engagement structure comprises a channel extending into the thickness from one surface.

13. The woodwind mouthpiece ligature of claim 12, wherein the engagement structure comprises a ridge extending up from one surface.

14. The woodwind mouthpiece ligature of claim 12, wherein the engagement structure comprises a cradle comprising:
two peaks extending up from one surface to a peak height and spaced from each other along the length; and
a cradle thickness that varies along the length between the two peaks, the cradle thickness less than the ridge peak.

15. A woodwind mouthpiece comprising:
a mouthpiece of a woodwind instrument;
a reed in contact with the mouthpiece, and
a woodwind mouthpiece ligature comprising a plurality of components to secure the reed to the mouthpiece, wherein at least one component from the plurality of components comprises a printed component that is at least partially created by printing using a three-dimensional printer.

16. The woodwind mouthpiece of claim 15, wherein the printed component is completely created by printing using a three-dimensional printer.

17. The woodwind mouthpiece of claim 15, wherein the at least one component comprises a printed ligature strap.

18. A method for printing a woodwind mouthpiece ligature, the method comprising: creating a machine-readable file comprising a pre-defined configuration for a given component in a plurality of components in the woodwind mouthpiece ligature; and using the machine-readable file in a three-dimensional printer to print the given component.

19. The method of claim 18, wherein:
the pre-defined configuration defines the entire given component; and
using the machine-readable file comprises using the machine-readable file in the three-dimensional printer to print the given component completely.

20. The method of claim 18, wherein the given component comprises a printed ligature strap.
